(19) United States
(12) Patent Application Publication
(10) Pub. No.: US 2024/0010387 A1
(43) Pub. Date: Jan. 11, 2024

(54) MAGNETICALLY FOLDABLE BOX

(71) Applicant: GLOBAL STORE SUPPLY INC, Eastvale, CA (US)

(72) Inventor: Zhe YU, Eastvale, CA (US)

(21) Appl. No.: 17/948,498

(22) Filed: Sep. 20, 2022

(30) Foreign Application Priority Data
Jul. 5, 2022 (CN) 202221721253.4

(51) Int. Cl. B65D 5/66; B65D 5/18

(52) U.S. Cl. CPC B65D 5/6611; B65D 5/18

(57) ABSTRACT

The present application discloses a magnetically foldable box including a first folding and a second foldable plate; the second foldable plate forms a frame body with two open ends; the first foldable plate includes a bottom plate; one of edges of the frame body is connected with an edge of the bottom plate, so that the frame body is operable to turn toward the bottom plate; the frame body is provided with a detachable connector, and is detachably connected with the bottom plate via the detachable connector; and the first foldable plate is configured to enclose the frame body and close the two open ends of the frame body, and be magnetically fixed with the frame body at overlapping positions with the frame body.

### CROSS-REFERENCE TO RELATED APPLICATION

The present application claims the priority benefit of China application No. 202221721253.4, filed on Jul. 5, 2022. The entirety of China application No. 202221721253.4 is incorporated herein by reference and made a part of this specification.

### TECHNICAL FIELD

The present application relates to the technical field of foldable box, and in particular to a magnetically foldable box.

### BACKGROUND

Packaging boxes are mostly in a three-dimensional form in the process of manufacturing, storage and transportation and use, however, they need to occupy space in the transportation, storage and other non-use state. Therefore, foldable boxes are designed so that they can be folded in non-use states to reduce space occupancy.

A traditional foldable box is composed of a whole piece of paper sheet. The fastening positions are located at the bottom of the box body when the box body is in a three-dimensional form. In order to enhance the strength of the paper sheet, it's generally necessary to set a backing layer inside the box body, so as to make up for the defect of insufficient strength of the paper sheet.

In summary, the fastening positions on the foldable box needs to be disassembled and assembled one by one when disassembling and assembling a foldable box in a non-use state, which is relatively complicated; and since the fastening positions are generally provided at the bottom of the foldable box, the bearing force of the bottom of the foldable box is insufficient, so it is difficult to support relatively heavy items. Therefore, there is still room for improvement to meet the requirements of stable connection and convenient disassembly and assembly of the foldable box.

### SUMMARY

In order to meet the requirement of the stable connection of a foldable box and improve the convenience of disassembling and assembling the foldable box, the present application provides a magnetically foldable box.

The magnetically foldable box provided in the present application adopts the following technical solution:

a magnetically foldable box, including a first foldable plate and a second foldable plate; wherein, the second foldable plate forms a frame body with two open ends; the first foldable plate includes a bottom plate, and one of edges of the frame body is connected with an edge of the bottom plate, so that the frame body is operable to turn toward the bottom plate; the frame body is provided with a detachable connector, and is detachably connected with the bottom plate via the detachable connector; and the first foldable plate is configured to enclose the frame body and close the two open ends of the frame body, and be magnetically fixed with the frame body at overlapping positions with the frame body.

By adopting the above technical solution, the foldable box is divided into two parts: a first foldable plate and a frame body, in which the first foldable plate may be folded in a plurality of sections, and the frame body may be folded and deformed, simplifying the connecting steps when the foldable box is changed to a three-dimensional form. The edge of the bottom plate is connected to the frame body via the detachable connector, and the surface-to-surface connection between the frame body and the first foldable plate is achieved by magnetic attraction. The combination of the two connection methods not only meets the stable requirement of the foldable box, but also solves the problem of complex folding and disassembling steps of the foldable box; and by reducing the adhesive bonding area, it is conducive to reducing the damage degree of the foldable box when disassembling and increase the reuse rate of the foldable box.

In some embodiments, the detachable connector is peelable adhesive.

By adopting the above technical solution, the frame body is bonded and fixed to the first foldable plate by the peelable adhesive, so that it is convenient to tear off, under the condition that the requirement of the stable connection between the foldable box is met. At the same time, the damage to the first foldable plate may be reduced, and the reuse rate of the foldable box is increased.

In some embodiments, a surface of the bottom plate is provided with a backing plate.

By adopting the above technical solution, the backing plate plays the role of increasing the bearing force of the bottom plate to meet the load-bearing requirements for heavy items.

In some embodiments, edges of the backing plate abuts against the inside wall of the frame body at the bottom when the magnetically foldable box is changed to a three-dimensional form.

By adopting the above technical solution, the backing plate can not only play the role of enhancing the strength of the bottom plate, but also play the role of positioning the frame body, which is conducive to improving the folding efficiency of the foldable box in a three-dimensional form.

In some embodiments, the detachable connector is a connecting piece; a side of the backing plate is formed with a slot; and the connecting piece is configured to be inserted into the slot for fixing.

By adopting the above technical solution, not only the connection purpose between the frame body and the bottom plate is realized, but also the connecting piece plays a rigid supporting role to the backing plate, which is conducive to further improving the connection stability between the first foldable plate and the frame body.

In some embodiments, an edge portion of the bottom plate extends beyond an outer side wall of the frame body when the magnetically foldable box is changed to a three-dimensional form.

By adopting the above technical solution, the frame body is located on the surface of the bottom plate when the foldable box is changed to a three-dimensional form, which is conducive to improving the stability of the foldable box in a three-dimensional form.

In some embodiments, an outer side wall of the frame body is attached to a surface of the edge portion of the bottom plate when the foldable box is changed to a flat folded form.

By adopting the above technical solution, the frame body is folded to one side of the first foldable plate to make the foldable box be in a flat folded form, and the edge portion plays a supporting role for the first foldable plate folded into a flat state, so as to prevent the frame body from turning down excessively, which is conducive to keeping the foldable box flat in a non-use state to facilitate the storage and transportation of the foldable box.

In some embodiments, the connecting piece is a plastically deformable piece.

Since edges of the backing plate abuts against the inside wall of the frame body at the bottom, it is inconvenient for users to complete the step of inserting a rigid connecting piece into the slot in the limited space between the bottom plate and the frame body, therefore, by adopting the connecting piece with plastically deformable function, users can gradually adjust the direction of the inserting section of the connecting piece during inserting, to facilitate the inserting and connecting.

In some embodiments, the connecting piece is configured to be bendable and insertion fixed into the slot by a bent portion when the magnetically foldable box is changed to a three-dimensional form.

By adopting the above technical solution, the connecting piece is horizontally inserted into the slot, which, together with the magnetic attraction fixation between the frame body and the first foldable plate, is conducive to further improving the connection stability between the frame body and the backing plate.

In some embodiments, the connecting piece is configured to have a horizontal projection at the bottom plate and form a limiting structure together with the edge portion of the bottom plate for preventing the frame body from being moved vertically when the magnetically foldable box is changed to a flat folded form.

By adopting the above technical solution, the upper and lower positions of the second foldable plate are limited when the second foldable plate is in a flat state, to achieve the stability of the foldable box in a flat folded form. The bending angel of the connecting piece is adjusted based on the different states of the foldable box, so that the connecting piece plays a connecting role when the foldable box is in a three-dimensional form and plays a limiting role when the frame body is in a folded form, which is convenient for the storage, transportation and use of the foldable box.

In some embodiments, the magnetically foldable box further includes a partition member, and the partition member configured to divide a zone enclosed by the frame body into a plurality of storage zones.

By adopting the above technical solution, multiple objects may be stored in subarea, so as to stabilize the objects, and an anti-collision and anti-fall function is achieved.

In some embodiments, the partition member is detachably connected to the frame body.

By adopting the above technical solution, the partition member is detachably connected to the frame body, so that the partition member may be packed and used separately with the foldable box during transportation and sales. The partition member may be matched or not matched based on the demands of users and be used in different object scenes, which is conducive to improving the utilization efficiency of the product.

In some embodiments, the partition member is cross-shaped, and four ends of the partition member abut against four inside walls of the frame body, respectively.

By adopting the above technical solution, the partition member provides pretightening force for the side wall of the frame body, which is conducive to improving the compression capacity of the frame body.

In some embodiments, the first foldable plate further includes a front plate; the front plate is connected to a front side of the bottom plate; and a connecting piece is arranged on an outer surface of a front plate, and configured to extend from the outer surface of the front plate to an inside wall of the frame body and be fixed with the inside wall of the frame body by magnetic attraction when the foldable box is changed to a three-dimensional form.

By adopting the above technical solution, it is conducive to improving the connection stability between the frame body and the first foldable plate.

In some embodiments, the first foldable plate further includes a front plate, a rear plate, a cover plate and a lapping plate; the front plate, the bottom plate, the rear plate, the cover plate and the lapping plate are successively connected; and the cover plate is configured for closing an upper open end of the frame body.

In some embodiments, a front side of the frame body is configured to be fixed to an inner side of the front plate by magnetic attraction; a back side of the frame body is configured to be fixed to an inner side of the rear plate by magnetic attraction; and the lapping plate is configured to be fixed to an outer side of the front plate by magnetic attraction, when the magnetically foldable box is changed to a three-dimensional form.

In some embodiments, the lapping plate is fixed to the front plate by magnetic attraction when the magnetically foldable box is changed to a flat folded form.

In some embodiments, the slot is configured as elongated shape.

In some embodiments, a connecting section is adhesively fixed to the bottom of an inside wall of the frame body; the connecting section extends out of an lower open end of the frame body; the detachable connector is arranged on a matching face of the connecting section; and the matching face of the connecting section is configured to attach to a surface of the backing plate and be bonded to the surface of the backing plate via the detachable connector after the frame body stands on a surface of the bottom plate.

In some embodiments, a connecting section is sandwiched between the backing plate and the bottom plate; and the matching face of the connecting section is configured to be attached to and adhesively fixed with an inside wall of the frame body via the detachable connector, when the magnetically foldable box is changed to a three-dimensional form and the frame body and the bottom plate are connected with each other.

In summary, the present application has at least one of the following beneficial technical effects:

1. the foldable box is divided into two parts: a first foldable plate and a frame body, in which the first foldable plate may be folded in a plurality of sections, and the frame body may be folded and deformed, simplifying the connecting steps when the foldable box is changed to a three-dimensional form; the folding steps are simplified by detachable connection and magnetic attraction fixation, which is conducive to not only meeting the requirements of stable connection of the foldable box, but also improving the convenience of the disassembly and assembly of the foldable box and increasing the reuse rate of the foldable box;

2. The bending angel of the connecting piece is adjusted based on the different states of the foldable box, so that the connecting piece plays a connecting role when the first foldable plate is in a three-dimensional form, and plays a limiting role when the frame body is in a folded form, which is convenient for the storage, transportation and use of the foldable box.

### BRIEF DESCRIPTION OF THE DRAWINGS

FIG. 1 is a schematic diagram of the first foldable plate of embodiment 1 in unfolded form.

FIG. 2 is an enlarged diagram at A in FIG. 1.

FIG. 3 is a schematic diagram of the hexagonal foldable box of embodiment 1 in a three-dimensional form.

FIG. 4 is a schematic diagram of the foldable box of embodiment 1 in three-dimensional the form.

FIG. 5 is a schematic diagram of the foldable box of embodiment 1 in flat folded form.

FIG. 6 is a schematic diagram of the positions of the foldable box and the partition plate of embodiment 1.

FIG. 7 is a schematic diagram of the foldable box of embodiment 2 in a three-dimensional form.

FIG. 8 is a schematic diagram of the connection between the connecting piece and the slots of embodiment 2.

FIG. 9 is a schematic diagram of the foldable box of embodiment 2 in flat folded form.

FIG. 10 is a schematic diagram of the foldable box of embodiment 3 in a three-dimensional form.

FIG. 11 is an enlarged diagram at B in FIG. 9.

FIG. 12 is a schematic diagram of the foldable box of embodiment 4 in a three-dimensional form.

FIG. 13 is a schematic diagram of the frame body and the first foldable plate of embodiment 4 when they are separated.

FIG. 14 is a schematic diagram of the frame body and the first foldable plate of embodiment 4 when they are connected.

### DESCRIPTION OF THE EMBODIMENTS

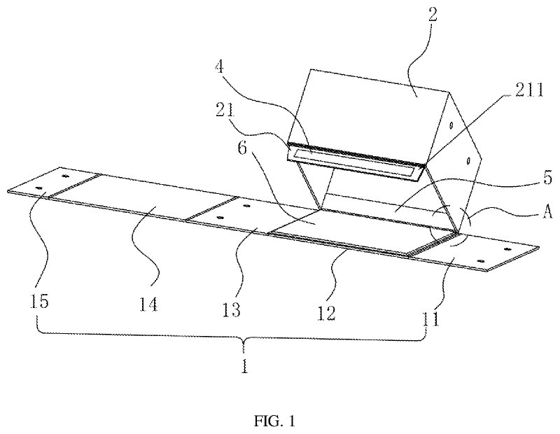

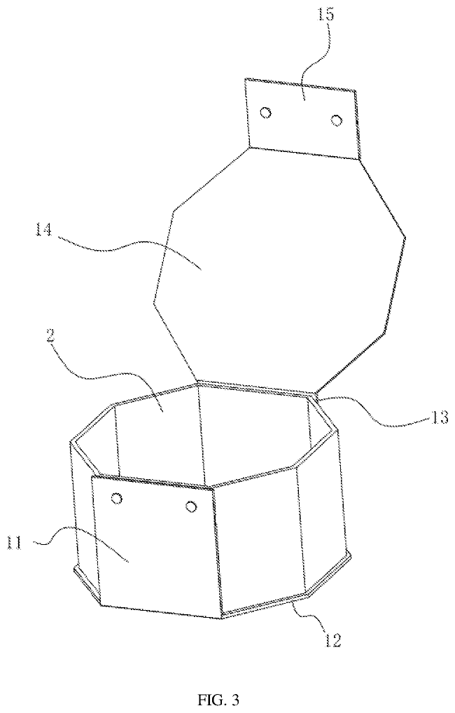

The present application will be further described in detail in combination with FIGS. 1-10.

### Embodiment 1

The embodiment 1 in the present application discloses a magnetically foldable box. Referring to FIGS. 1-3, the magnetically foldable box includes a first foldable plate 1 and a second foldable plate 2; both of the first foldable plate 1 and the second foldable plate are made of paperboard; and the first foldable plate 1 is divided into five sections: a front plate 11, a bottom plate 12, a rear plate 13, a cover plate 14 and a lapping plate 15 from right to left. The second foldable plate is divided into four sections; the four sections form a rectangular frame body; the rectangular frame body is closed on the periphery and open on the upper and lower ends; and the frame body may be folded and deformed into flat folded form. In other embodiments, the second foldable plate 2 may be divided into a plurality of sections based on actual demands; the plurality of sections form a polygon prism-shaped frame body; and the second foldable plate may be combined with the first foldable plate 1 to form a polygon prism-shaped box body.

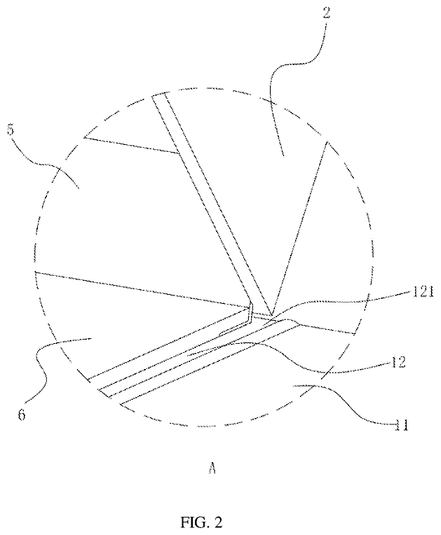

Referring to FIGS. 1 and 2, the first foldable plate 1 and the second foldable plate 2 are connected by a cardboard piece 5, and the cardboard piece 5 may be replaced with other foldable connecting parts; in this embodiment, the cardboard piece 5 is adhered to the edge portion 121 of the bottom plate 12 and the bottom of the inside wall of the frame body, so that the frame body may be turned toward the bottom plate 12. The foldable box may be transformed between a three-dimensional form and a flat folded form; the frame body in a flat folded form is folded on one side of the first foldable plate 1; when the foldable box is changed to a three-dimensional form, the frame body stands on the surface of the bottom plate 12; the first foldable plate 1 surrounds the frame body; the bottom plate 12 closes a lower open end of the frame body; and the cover plate 14 closes an upper open end of the frame body, so as to achieve the purpose of rapidly folding the foldable box and facilitate the storage, transportation and use.

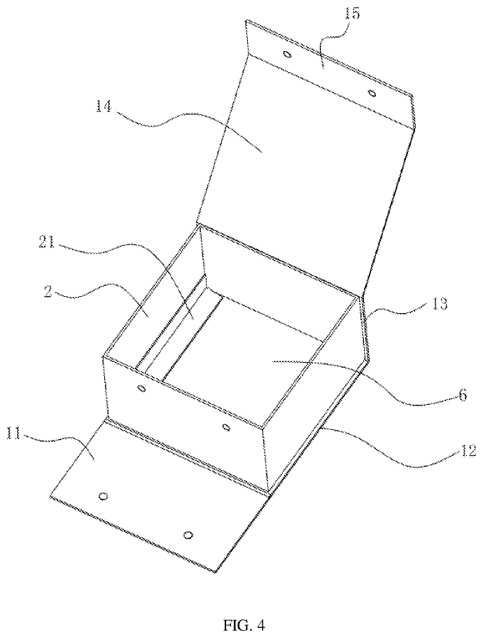

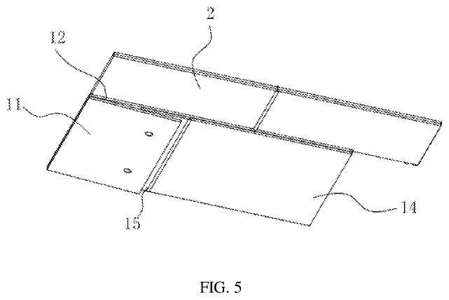

Referring to FIGS. 4 and 5, in order to achieve rapid disassembly and assembly, and connection stability of the foldable box, the overlapping positions of the first foldable plate 1 and the second foldable plate 2 is fixed by the way of magnetic attraction. Specifically, magnets are embedded into the front plate 11, the rear plate 13 and the lapping plate 15 of the first foldable plate 1, respectively; and magnets are embedded into the front side and the back side of the frame body, respectively. When the foldable box is changed to a three-dimensional form, the front side of the frame body is fixed to the inner side of the front plate 11 by magnetic attraction; the back side of the frame body is fixed to the inner side of the rear plate 13 by magnetic attraction; and the lapping plate 15 is fixed to the outer side of the front plate 11 by magnetic attraction. When the foldable box is changed to a flat folded form, the front plate 11, the cover plate 14 and the lapping plate 15 are folded on the lower surface of the bottom plate 12; and the lapping plate 15 is fixed to the front plate 11 by magnetic attraction.

The surface of the bottom plate 12 is adhesively fixed with a backing plate 6, and the part of the bottom plate 12 where the cardboard piece 5 is adhered is covered by the backing plate 6, so that the cardboard piece 5 is bonded firmly in the interlayer space formed by the backing plate 6 and the bottom plate 12. The area of the backing plate 6 is smaller than the area of the bottom plate 12; and the backing plate 6 is centrally arranged. When the foldable box is changed to a three-dimensional form, edges of the backing plate 6 abuts against the inside wall of the frame body, and at the same time the backing plate 6 plays a role of enhancing the strength of the bottom plate 12, stabilizing the cardboard piece 5 and positioning the frame body.

In addition, an edge portion 121 of the bottom plate 12 extends beyond an outer side wall of the frame body when the foldable box is changed to a three-dimensional form; an outer side wall of the frame body is attached to a surface of the edge portion 121 of the bottom plate 12 when the foldable box is changed to a flat folded form; and the edge portion 121 of the bottom plate 12 plays a supporting role for the frame body in the flat state, which can prevent the frame body from turning down excessively, so as to improve the stability of the foldable box during storage and transportation.

Referring to FIGS. 1 and 4, a detachable connector is provided at the bottom of the inside wall of the frame body, and in this embodiment, the detachable connector is peelable adhesive; a connecting section 21 is adhesively fixed to the bottom of the inside wall of the frame body, and the connecting section 21 is made of cardboard; the connecting section 21 extends out of a lower open end of the frame body; the connecting section 21 is arranged opposite to the cardboard piece 5; the peelable adhesive is bonded to a matching face 211 of the connecting section 21; the matching face 211 of the connecting section 21 is configured to attach to the surface of the backing plate 6 and be bonded firmly by the peelable adhesive after the frame body stands on the surface of the bottom plate 12.

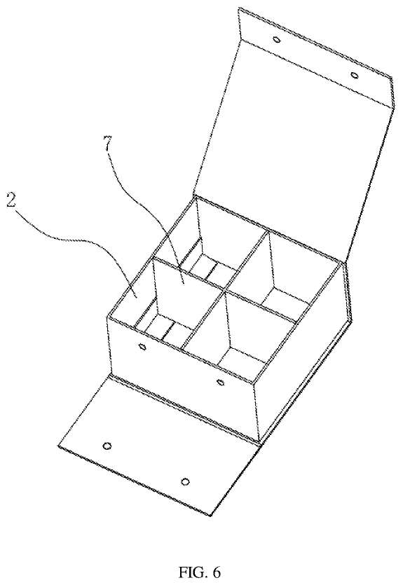

Referring to FIGS. 4 and 6, additionally, the foldable box further includes a partition member 7; the partition member 7 is detachably connected to the frame body. Specifically, the partition member 7 includes two partition plates and the two partition plates are configured to be cross-shaped; and the partition plates are positioned in the internal cavity of the frame body, thus dividing a zone enclosed by the frame body into 4 storage zones to stabilize objects and help improving the use efficiency of the product.

The implementing principle of the magnetically foldable box of embodiment 1 in the present application is as follows:

the foldable box is changed to a three-dimensional form for use. Firstly, the frame body is turned toward the upper surface of the bottom plate 12, and edges of the backing plate 6 abut against an inside wall of the frame body to make the frame body stand on the upper surface of the bottom plate 12; then the connecting section 21 is bonded to the surface of the backing plate 6 by the peelable adhesive; and the frame body is enclosed by the first foldable plate 1; an upper open end of the frame body is covered by the cover plate 14; and the overlapping positions of the frame body and the first foldable plate 1 is fixed by magnetic attraction.

The foldable box is changed to a flat folded form for storage and transportation. Firstly the connecting section 21 is separated from the backing plate 6; the front plate 11 is separated from the front side of the frame body; the rear plate 13 is separated from the back side of the frame body; then the frame body is turned to one side of the first foldable plate 1 and folded into a flat state; the front plate 11, the cover plate 14 and the lapping plate 15 are folded at the lower surface of the bottom plate 12; and the lapping plate 15 is fixed with the front plate 11 by magnetic attraction.

Embodiment 2 differs from embodiment 1 in that:

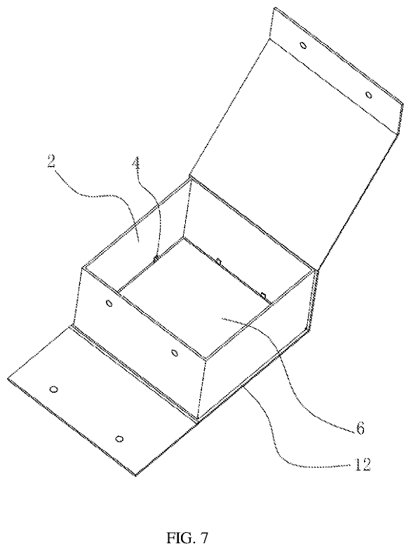

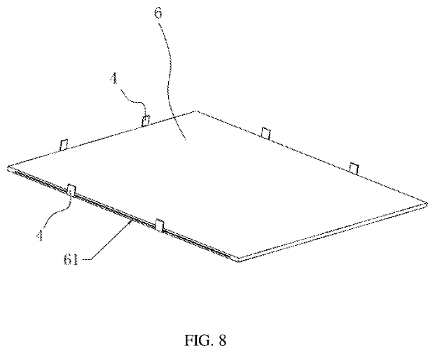

Referring to FIGS. 7 and 8, the detachable connector is specifically a connecting piece, and the connecting piece is a plastically deformable piece, such as a deformable steel sheet; specifically, the connecting piece is fixed at the bottom of the inside wall of the frame body; and the connecting piece is configured to extend out of an open end of the frame body at the bottom. In this embodiment, except for the side of the frame body connected with the cardboard piece 5, other sides of the frame body are all provided with two connecting pieces. In addition, a side of the backing plate 6 is provided with a slot 61 configured for the connecting piece to be inserted; in order to facilitate the insertion of the connecting piece into the slot 61, the slot 61 is configured to be elongated shape; the connecting pieces 4 configured to be bendable and insertion fixed into the slots 61 by a bent portion and play a rigid supporting role for the backing plate 6, when the foldable box is changed to a three-dimensional form, which is conducive to further improving the connection stability between the first foldable plate 1 and the frame body, and at the same time, it is easy to disassemble the first foldable plate 1 and the frame body, which is conducive to increasing the reuse rate of the foldable box.

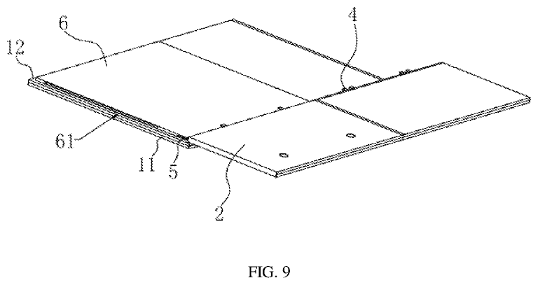

Referring to FIG. 9, when the foldable box is changed to a flat folded form, by straightening the connecting pieces 4, the horizontal projections of the connecting pieces 4 are located at the backing plate 6 on the surface of the bottom plate 12; the connecting pieces 4 and the edge portion 121 of the bottom plate 12 together form a limiting structure for preventing the frame body from being moved vertically, which further improves the overall stability of the foldable box in a flat folded form.

The implementing principle of the magnetically foldable box of embodiment 2 in the present application is as follows:

when the foldable box is changed to a three-dimensional form. Firstly the connecting pieces 4 are bended by 90° toward the inner side of the frame body, and the frame body in the flat state stands up; during the expanding of the frame body to a rectangle state, the steps of inserting the connecting pieces 4 on each side of the frame body into the slots are completed step by step; the insertion is performed based on the expanding direction of the frame body. The connecting pieces 4 on the side of the frame body adjacent to the cardboard piece 5 is inserted into the slot 61 firstly, and, since the insertion direction of the connecting pieces 4 on this side is the same as the expanding direction of the frame body, the connecting pieces 4 can be inserted into the slot directly. Since the insertion direction of the connecting pieces 4 on the other two sides of the frame body is different from the expanding direction of the frame body, when the other two sides of the frame body are completely in place, the side walls of the frame body are pulled in the direction away from the backing plate 6 based on the deformation capacity of the frame body and its own cardboard material properties, to make the space between the side wall of the frame body and the side of the backing plate 6 be widened for a short time so that the connecting pieces 4 can be in place, and then the transverse insertion of the connecting pieces 4 into the slots is completed.

In order to achieve the purpose of inserting the connecting pieces 4 into the slots, the area of the backing plate 6 is smaller than the area enclosed by the frame body, so that when the frame body is in place, there is a certain gap between the backing plate 6 and the inner side of the frame body, to facilitate the subsequent insertion operations.

When the foldable box is changed to a flat folded form. Firstly the connecting pieces 4 are separated from the slots 61 in the backing plate 6 one by one, then the frame body is turned to one side of the first foldable plate 1, and folded to a flat state; the connecting pieces 4 are straightened to make the connecting pieces be pressed on the surface of the backing plate 6, so that the connecting pieces 4 and the edge portion 121 of the bottom plate 12 together form a limiting structure for preventing the frame body from being moved vertically, further improving the overall stability of the foldable box in a flat folded form.

Embodiment 3 differs from embodiment 1 in that:

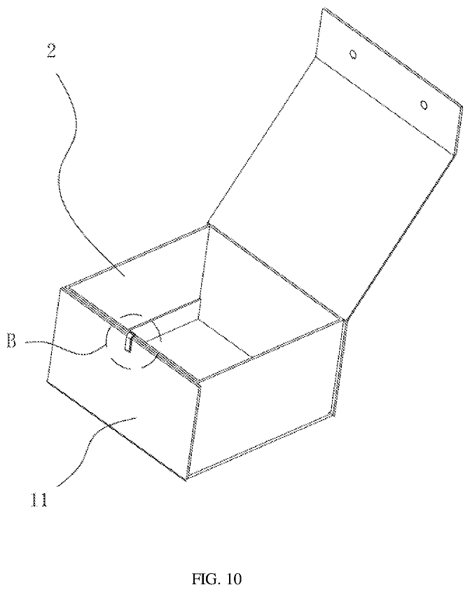

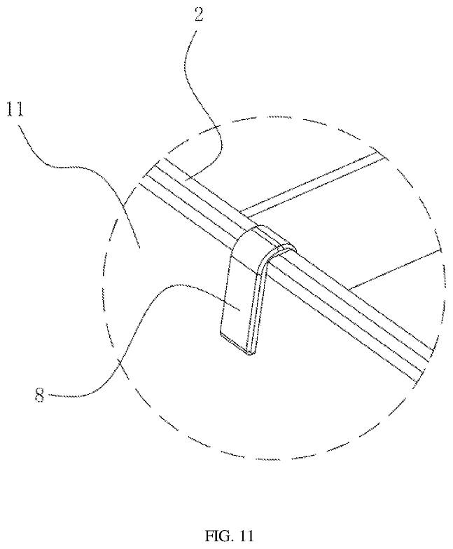

referring to FIGS. 10 and 11, the front plate 11 is provided with a connector, and the connector is a folding piece 8; when the foldable box is changed to a three-dimensional form, the side of the front plate 11 away from the frame body acts as the outer surface of the front plate 11, and the fixing end 213 of the folding piece 8 is fixed at the outer surface of the front plate 11. The end of the folding piece 8 away from the front plate 11 acts as an connecting end 212 of the folding piece 8; and the connecting end 212 of the folding piece 8 is embedded with a magnet; when the foldable box is changed to a three-dimensional form, the folding piece 8 extends from the outer surface of the front plate 11 to the inside wall of the frame body; and the magnet at the connecting end 212 of the folding piece is fixed with the magnet at the front side of the frame body by magnetic attraction, which is conducive to improving the connection stability between the frame body and the first foldable plate 1.

Embodiment 4 differs from embodiment 1 in that:

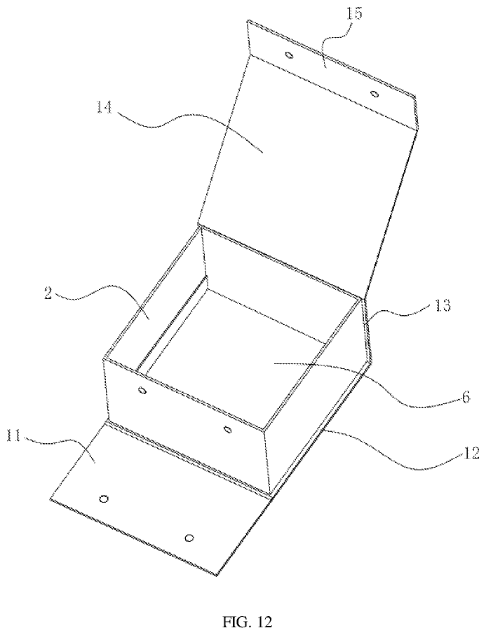

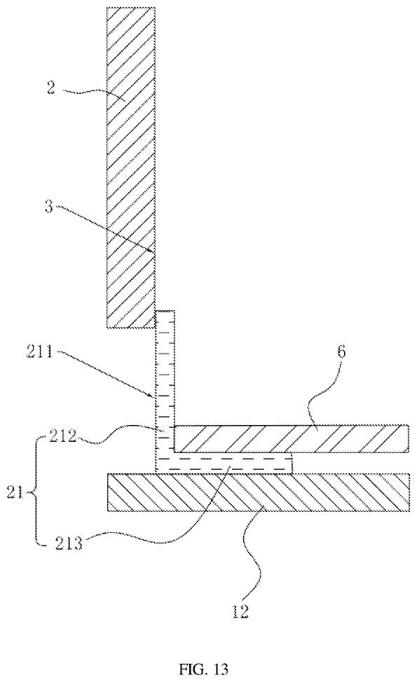

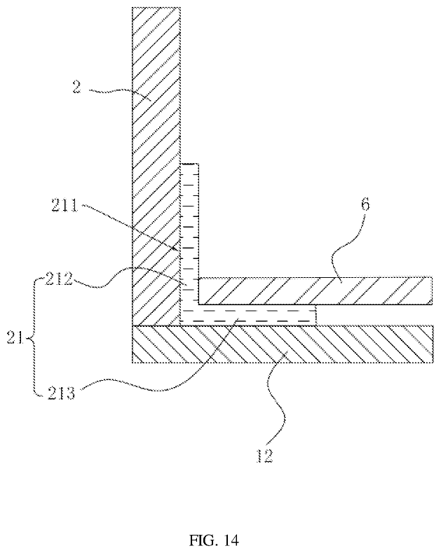

referring to FIGS. 13 and 14, the fixing end 213 of the connecting section 21 is adhesively fixed between the backing plate 6 and the bottom plate 12, and the connecting end 212 of the connecting section 21 is located out of the space between the backing plate 6 and the bottom plate 12. When connecting the frame body and the bottom plate 12, the connecting end 212 of the connecting section 21 is bended by 90° and stands up; the peelable adhesive is laid on the matching face 211 of the connecting section 21; then edges of the backing plate 6 abuts against the inside wall of the frame body at the bottom to make the matching face 211 be attached to the inside wall of the frame body and be fixed by the peelable adhesive. By this fixing manner, the connecting section 21 has same connection manner with the cardboard piece 5, which is better implemented in the process. Referring to FIG. 12, it is visually uniform and conducive to the aesthetics of the foldable box.

The above description is only alternative embodiments of the present application and is not intended to limit the protection scope of the present application. Therefore, any equivalent variations made according to the structures, shapes and principles of the specification in the present application, should fall within the protection scope of the present application.

What is claimed is:

1. A magnetically foldable box, comprising a first foldable plate and a second foldable plate; wherein the second foldable plate forms a frame body with two open ends; the first foldable plate comprises a bottom plate; one edge of the frame body is connected with an edge of the bottom plate so that the frame body is operable to turn toward the bottom plate; the frame body is provided with a detachable connector and is detachably connected with the bottom plate via the detachable connector; and the first foldable plate is configured to enclose the frame body, close the two open ends of the frame body, and be magnetically fixed with the frame body at overlapping positions with the frame body.

2. The magnetically foldable box according to claim 1, wherein the detachable connector is a peelable adhesive.

3. The magnetically foldable box according to claim 1, wherein a surface of the bottom plate is provided with a backing plate.

4. The magnetically foldable box according to claim 3, wherein edges of the backing plate abut against an inside wall of the frame body at a bottom of the inside wall of the frame body when the magnetically foldable box is changed to a three-dimensional form.

5. The magnetically foldable box according to claim 3, wherein the detachable connector is a connecting piece; a side of the backing plate is formed with a slot; and the connecting piece is configured to be inserted into the slot for fixing.

6. The magnetically foldable box according to claim 1, wherein an edge portion of the bottom plate extends beyond an outer side wall of the frame body when the magnetically foldable box is changed to a three-dimensional form.

7. The magnetically foldable box according to claim 6, wherein the outer side wall of the frame body is attached to a surface of the edge portion of the bottom plate when the magnetically foldable box is changed to a flat folded form.

8. The magnetically foldable box according to claim 5, wherein the connecting piece is a plastically deformable piece.

9. The magnetically foldable box according to claim 8, wherein the connecting piece is configured bend and be insertion fixed into the slot by a bent portion when the magnetically foldable box is changed to a three-dimensional form.

10. The magnetically foldable box according to claim 9, wherein the connecting piece is configured to have a horizontal projection at the bottom plate and form a limiting structure together with an edge portion of the bottom plate for preventing the frame body from being moved vertically when the magnetically foldable box is changed to a flat folded form.

11. The magnetically foldable box according to claim 1, wherein the magnetically foldable box further comprises a partition member configured to divide a zone enclosed by the frame body into a plurality of storage zones.

12. The magnetically foldable box according to claim 11, wherein the partition member is detachably connected to the frame body.

13. The magnetically foldable box according to claim 12, wherein the partition member is cross-shaped, and four ends of the partition member abut against four inside walls of the frame body, respectively.

14. The magnetically foldable box according to claim 1, wherein the first foldable plate further comprises a front plate; the front plate is connected to a front side of the bottom plate; and a connecting piece is provided on an outer surface of the front plate and configured to extend from the outer surface of the front plate to an inside wall of the frame body and be fixed with the inside wall of the frame body by magnetic attraction when the magnetically foldable box is changed to a three-dimensional form.

15. The magnetically foldable box according to claim 1, wherein the first foldable plate further comprises a front plate, a rear plate, a cover plate and a lapping plate; the front plate, the bottom plate, the rear plate, the cover plate and the lapping plate are successively connected; and the cover plate is configured for closing an upper open end of the frame body.

16. The magnetically foldable box according to claim 15, wherein a front side of the frame body is configured to be fixed to an inner side of the front plate by magnetic attraction; a back side of the frame body is configured to be fixed to an inner side of the rear plate by magnetic attraction; and the lapping plate is configured to be fixed to an outer side of the front plate by magnetic attraction, when the magnetically foldable box is changed to a three-dimensional form.

17. The magnetically foldable box according to claim 15, wherein the lapping plate is fixed to the front plate by magnetic attraction when the magnetically foldable box is changed to a flat folded form.

18. The magnetically foldable box according to claim 5, wherein the slot has an elongated shape.

19. The magnetically foldable box according to claim 3, wherein a connecting section is adhesively fixed to a bottom of an inside wall of the frame body; the connecting section extends out of a lower open end of the frame body; the detachable connector is arranged on a matching face of the connecting section; and the matching face of the connecting section is configured to attach to a surface of the backing plate and be bonded to the surface of the backing plate via the detachable connector after the frame body stands on a surface of the bottom plate.

20. The magnetically foldable box according to claim 3, wherein a connecting section is sandwiched between the backing plate and the bottom plate; and a matching face of the connecting section is configured to be attached to and adhesively fixed with an inside wall of the frame body via the detachable connector, when the magnetically foldable box is changed to a three-dimensional form and the frame body and the bottom plate are connected with each other.
